(19) United States
(12) Patent Application Publication
(10) Pub. No.: US 2006/0244557 A1
(43) Pub. Date: Nov. 2, 2006

(54) Mountable remote actuated circuit breaker driver

(76) Inventor: Richard W. Sorenson, Stuart, FL (US)

Correspondence Address: CANTOR COLBURN, LLP, 55 GRIFFIN ROAD SOUTH, BLOOMFIELD, CT, 06002, US

(21) Appl. No.: 11/415,684

(22) Filed: May 2, 2006

Related U.S. Application Data
(60) Provisional application No. 60/676,895, filed on May 2, 2005.

(51) Int. Cl. H01H 9/00

(52) U.S. Cl. 335/172

(57) ABSTRACT

An embodiment may comprise a remotely actuated circuit breaker actuator apparatus for use with a circuit breaker comprising: an actuator; and a mount for holding the actuator; wherein the circuit breaker is remotely actuated via the actuator.

### CROSS REFERENCE TO RELATED APPLICATIONS

This application claims priority to U.S. provisional application 60/676,895 filed May 2, 2005, the entire contents of which are incorporated hereby by reference.

### FIELD OF INVENTION

This invention is related to the circuit breaker art.

### BACKGROUND

Circuit breakers are commonly manually actuated. Remote actuators for circuit breakers are also known, however they typically are too complex and costly to be used in other than specialized and/or custom applications.

Environmental operating conditions also typically pose challenges to remotely actuated systems. For example, the United States military specifies that many circuit breakers conform to MILC 55-629 standards for resistance to humidity, salt spray, shock, and other factors. It follows that remote actuation systems having complex moving parts such as gears have more difficulty meeting these standards than less complex manual breakers. Additionally complex mechanical arms and/or geared parts can have lower performance when compared to other systems such as magnetically actuated parts where a more instantaneous response is achieved. Additionally, sensitivity to extreme environments and various electromagnetic radiation signals can cause computer controlled systems having circuit boards to be more fragile than other systems such as mechanical systems.

Additionally, circuit breakers are typically mounted in standardized shaped and sized panels of circuit breaker boxes. Therefore, competitors in the circuit breaker industry can minimize unnecessary additional system costs by conforming the physical dimensions of their breakers to established dimensions. Additionally, because circuit breakers are mounted next to each other for ease of use, “real estate” or physical space on the breaker box is at a premium. Therefore, a new device that occupies more space, and thereby reduces the overall number of breakers remaining in a breaker box is not usually desirable. Thus, a remotely actuated circuit breaker that requires two or three standard breakers to be removed—in order to substitute only a single remotely actuated breaker—is not preferred.

Additionally, some users may decide that remote actuation is desired only after they have already installed a manual circuit breaker system. For example, a ship may be manufactured with manual circuit breakers mounted in a breaker box, but subsequently a user may desire remote actuators to be retrofitted. Currently, there is no straightforward and cost effective device that can be easily mounted to pre-existing standard manual circuit breakers. Instead, typically in the prior art, any manual circuit breakers are removed and replaced by remotely actuatable circuit breakers. This is highly labor intensive and also usually requires that the electrical system be taken offline.

Having the option of using remotely actuatable circuit breakers is also desirable in military applications and other applications for safety and for operational speed and convenience concerns, e.g., during a battle.

Attempts have also been made to fit externally located remote actuator systems to circuit breakers such as is shown in U.S. Pat. No. 6,963,042 to Kouris. However, this system is too mechanically complex, unreliable, and costly to be practical, and thus would not withstand demanding applications such as military applications.

Applicant's company, Carling Technologies, also received U.S. Pat. No. 6,531,938 using an actuator tie pin with a motorized module that sits “beside” a traditional manual circuit breaker and takes the place or “space” of traditional circuit breakers in the electric panel. Thus, this not an application that can be quickly fitted “on top” of a preexisting circuit breaker panel for example in the manner of some of the present embodiments described below.

A retrofit switch actuator system is described in U.S. Pat. No. 5,762,180. However, as is easily seen in the figures, the system is large, complex, costly, and occupies a great amount of space. Therefore, it is not practical for easily retrofitting to conventional circuit breakers and panels which are located in limited spaces such as in breaker boxes or ship engine rooms for example.

A pneumatic operator for circuit breakers is described in U.S. Pat. No. 6,288,348. However, this patent only describes a pneumatic apparatus and is also too large to be easily retrofitted to many circuit breakers located side-by-side in a circuit box. Furthermore, most all users do not want to be burdened with the necessity of an air compressor, tubing, valves and other parts necessary to implement a pneumatic apparatus.

Thus, as stated above, reliability, complexity, cost, and space requirements have all contributed to substantial difficulties for those in the art to produce suitable and reliable remotely actuated circuit breaker drivers that can be retrofit easily for example. This is even more of an issue for military users who require robust and extremely reliable systems and who often require retrofit capability as well. Thus, a device that may solve some or all of these problems is needed.

### SUMMARY OF THE INVENTION

Thus, an embodiment may comprise a remotely actuated circuit breaker actuator apparatus for use with a circuit breaker having a switch actuator comprising: a solenoid; a moveable plunger actuated by the solenoid; a mount for holding the solenoid; wherein the mount is structured to be mountable to the exterior of the circuit breaker in order to position the plunger proximate to the switch actuator in order to actuate the switch actuator remotely via the solenoid.

An embodiment may also comprise a remotely actuated circuit breaker actuator apparatus for retrofitting to a circuit breaker located in a breaker box where the circuit breaker has a switch actuator, comprising: a module comprising: a solenoid; a moveable plunger actuated by the solenoid; a mount for holding the solenoid; wherein the mount is structured to be mountable above the circuit breaker in order to position the plunger proximate to the switch actuator in order to actuate the switch actuator remotely via the solenoid.

An embodiment may also comprise a system comprising: at least one circuit breaker having a switch actuator; at least one remotely actuated circuit breaker actuator apparatus for mating with each circuit breaker having a switch actuator comprising: a solenoid; a moveable plunger actuated by the solenoid; a mount for holding the solenoid; wherein the mount is mountable to the exterior of each circuit breaker in order to position the plunger proximate to the switch actuator in order to actuate the switch actuator remotely via the solenoid and wherein each circuit breaker is mated to a dedicated remotely actuated circuit breaker actuator apparatus; a breaker panel wherein each remotely actuated circuit breaker actuator apparatus may be mounted; a breaker box wherein the breaker panel is mounted; and control electronics linked to the circuit breakers and linked to each remotely actuated circuit breaker actuator apparatus via a communications connection for controlling the actuation of each remotely actuated circuit breaker actuator apparatus.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIGS. 1 and 1B are views of a third embodiment which slides onto a circuit breaker.

FIG. 1C is a perspective view of the third embodiment with an optional screw that mounts the mounting plate to the circuit breaker when the circuit breaker is made with a screw hole.

FIG. 2 is a side view a first embodiment with an optional cover located over the circuit breaker switch. The cover may be transparent.

FIG. 2a is a side view a modified version of the first embodiment having latches.

FIG. 3 is a cross sectional side view of a third embodiment.

FIG. 3A is a top view of a face plate 3 to be placed over circuit breaker.

FIG. 3B is a perspective view of a breaker box.

FIG. 3C is a perspective view of a breaker box with a cover installed. The cover may be transparent.

FIG. 3D is a perspective view of a breaker box and system.

FIG. 3E is a side view of an embodiment with a latch.

FIG. 3F is a plan view of an embodiment breaker box.

FIG. 4 is a top view of a circuit breaker with an embodiment of a remote actuator mounted thereon.

FIG. 4A is a cross sectional side view of the third embodiment and also shows an optional voltage trip circuit at the bottom the figure.

FIG. 5 is a cross sectional side view of the fourth embodiment.

FIG. 6 is a side view of a solenoid and a mounting frame.

FIG. 7 is a side view of the fifth embodiment.

FIG. 8 was deleted.

FIG. 9 is a sectional side view of a single pole solenoid and mounting frame.

FIG. 10 is a side sectional view of the sixth embodiment module 1d having springs to reduce or absorb the circuit breaker “turn-on” impact force.

FIG. 11 is a side sectional view of the seventh embodiment module 1e having springs to reduce or absorb the circuit breaker “turn-on” impact force.

FIG. 12 is a side sectional view of the eighth embodiment module 1f.

FIG. 13 is a side sectional view of the ninth embodiment module 1g having a hard stop.

FIG. 14 is a side view of an embodiment having a push button circuit breaker.

FIG. 15 is a side view of an embodiment having a rocker actuated circuit breaker.

FIG. 16 is a side view of another embodiment useable if there is no internal voltage trip coil in the circuit breaker.

### DETAILED DESCRIPTION OF THE PREFERRED EMBODIMENTS

First, it noted that circuit breakers do not have an infinite life span. Each unit can only survive a limited number of “overload” events and a limited number of severe overload events known as “short circuits” which are about ten times the load of an overload event. Thereafter they need to be replaced. Therefore, it is common for circuit breakers to be changed regularly especially in military specification settings such as according to MILC 55-629 standards. The MILC 55-629 standards are hereby incorporated by reference into this disclosure for reference. Additionally, complex mechanical gear systems are large in size with many moving parts like gears are also not as robust and are more subject to failure than magnetic solenoid systems. Therefore, although it is possible to make a remote actuator mechanism as part of one integral circuit breaker unit, such a unit would be large, more costly than a standard breaker, and would also be less reliable than a solenoid based system and lastly it would not be retrofittable to a typical circuit breaker located in a circuit breaker panel or box for example.

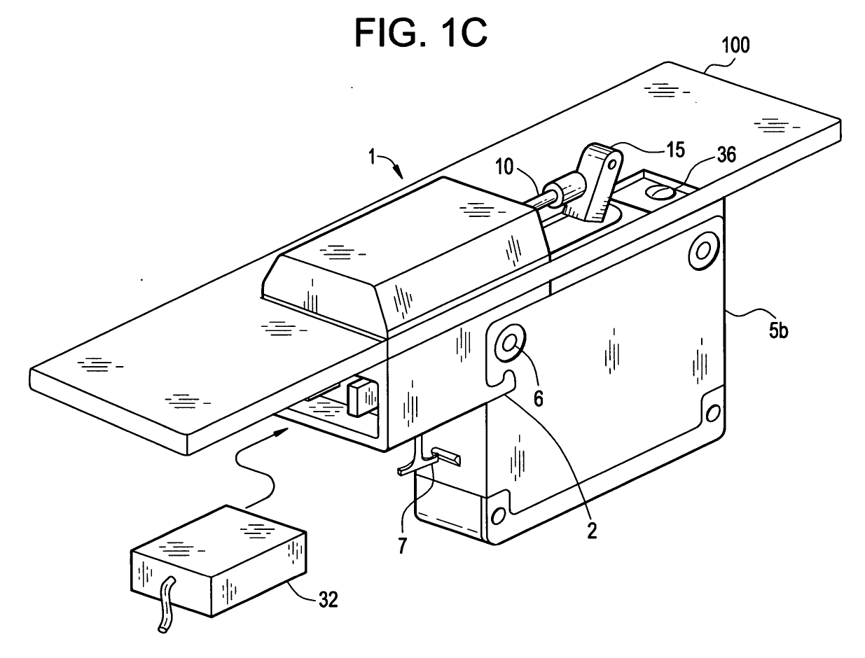

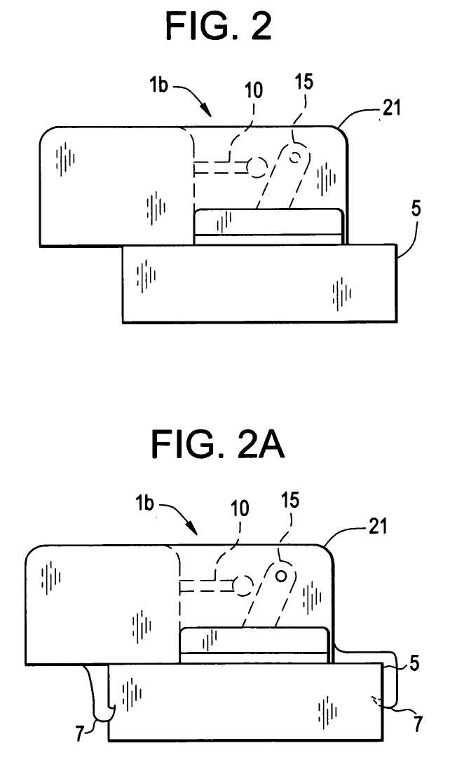

In contrast, in FIG. 2, it is readily seen that first embodiment, module 1b, may be easily retrofit to the top region of circuit breaker 5. In fact, many sizes and shapes of modules are envisioned according to the present invention, and many different attachment means are envisioned in order to mate easily with a circuit breaker 5 without requiring removal of adjacent circuit breakers from a breaker box for example. For example, wherein the width of the module 1b made be made to be no wider than the width of the circuit breaker 5 if desired so that no extra space is needed to made somehow between the existing circuit breaker installed in the breaker panel 100.

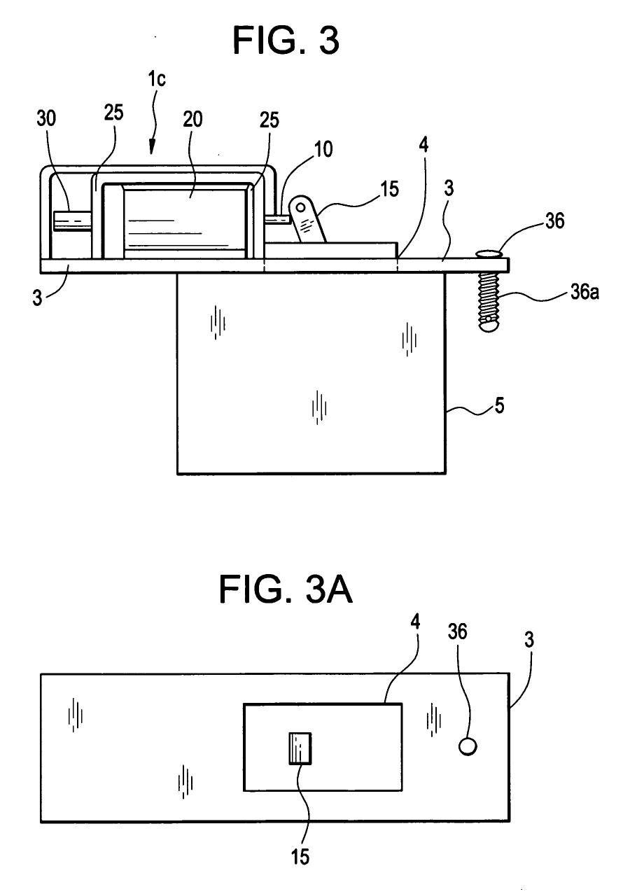

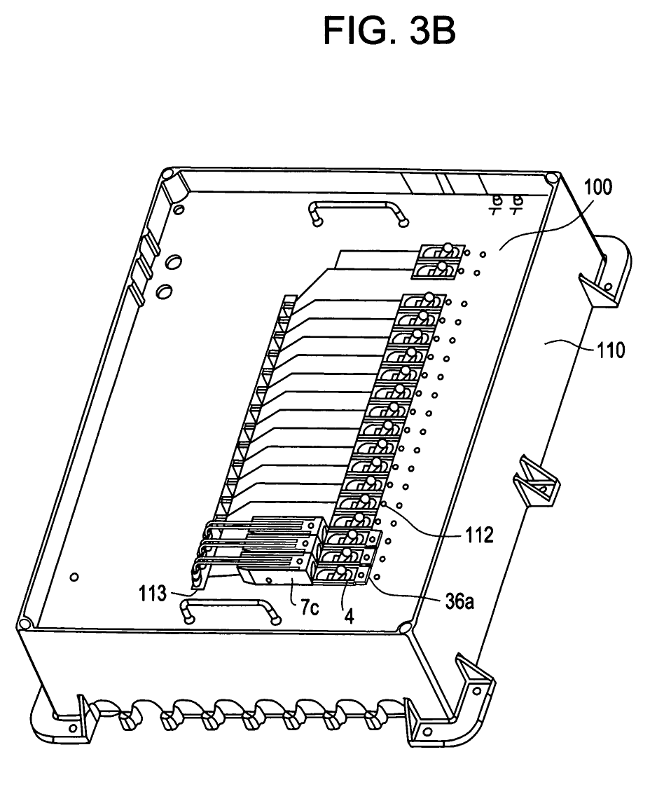

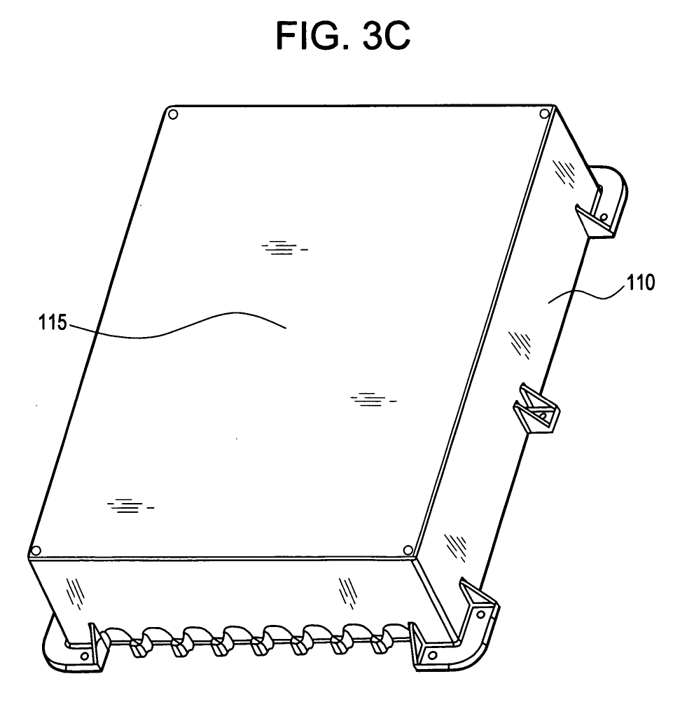

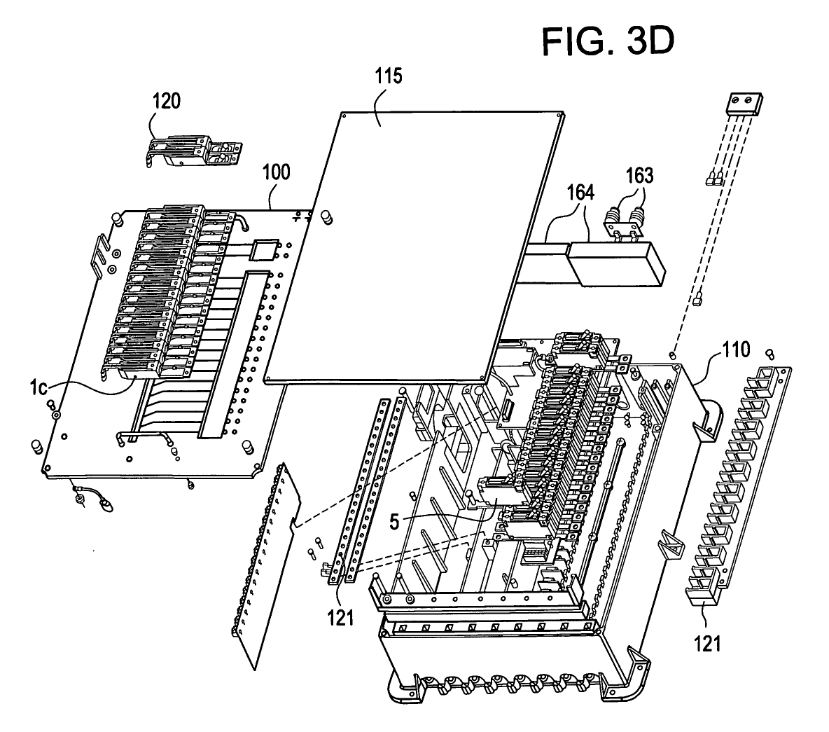

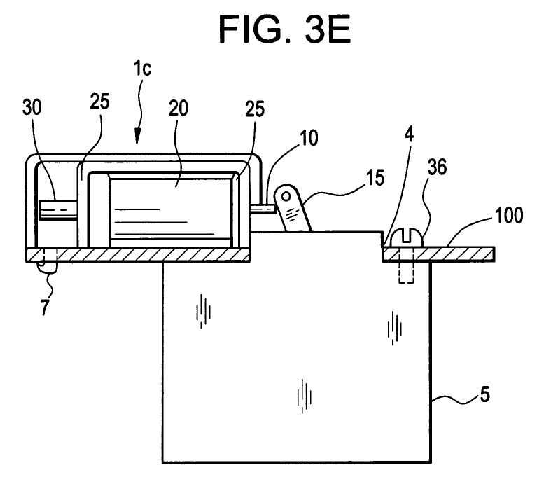

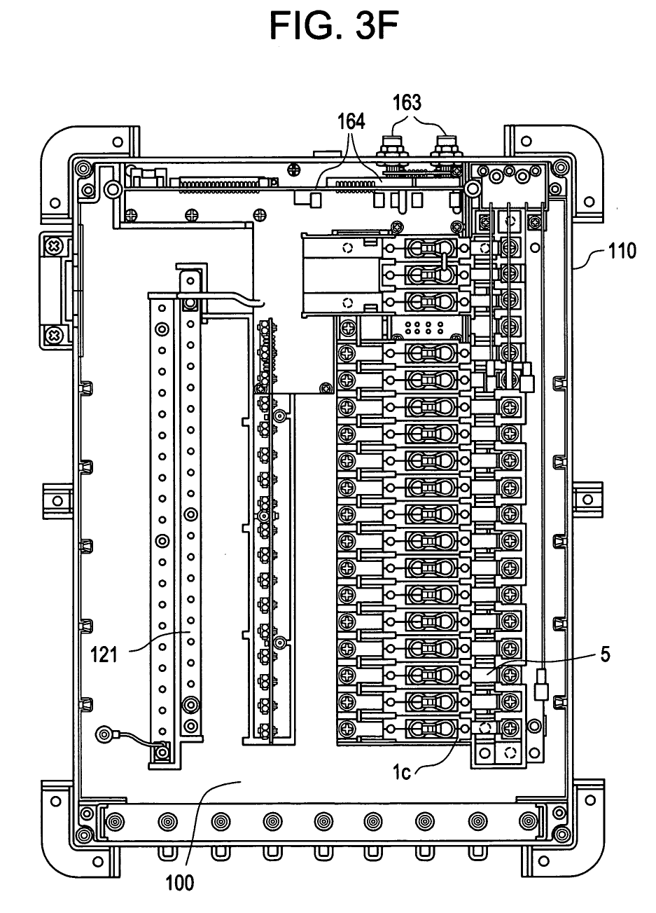

For example, in FIG. 2, it is seen how one embodiment, module 1b, can rest entirely above or “on top” of circuit breaker 5 if desired to minimize space requirements and to eliminate the need to remove any adjacent circuit breakers. Module 1b can be attached to circuit breaker 5 by any convenient method including but not limited to a pressure fit, adhesive binding, or fasteners such as screws or pins. In this way, a remotely actuated actuator module may be easily installed with a minimum of space requirements and/or may be easily retrofit to a circuit breaker 5. Module 1b, and other embodiments, may compromise an actuator plunger 10 which is moveable via solenoid actuation to contact circuit breaker 5 switch handle 15 in order to move switch handle 15 (See FIG. 3). Plunger 10 is connected to a solenoid 20 that moves plunger 10 axially.

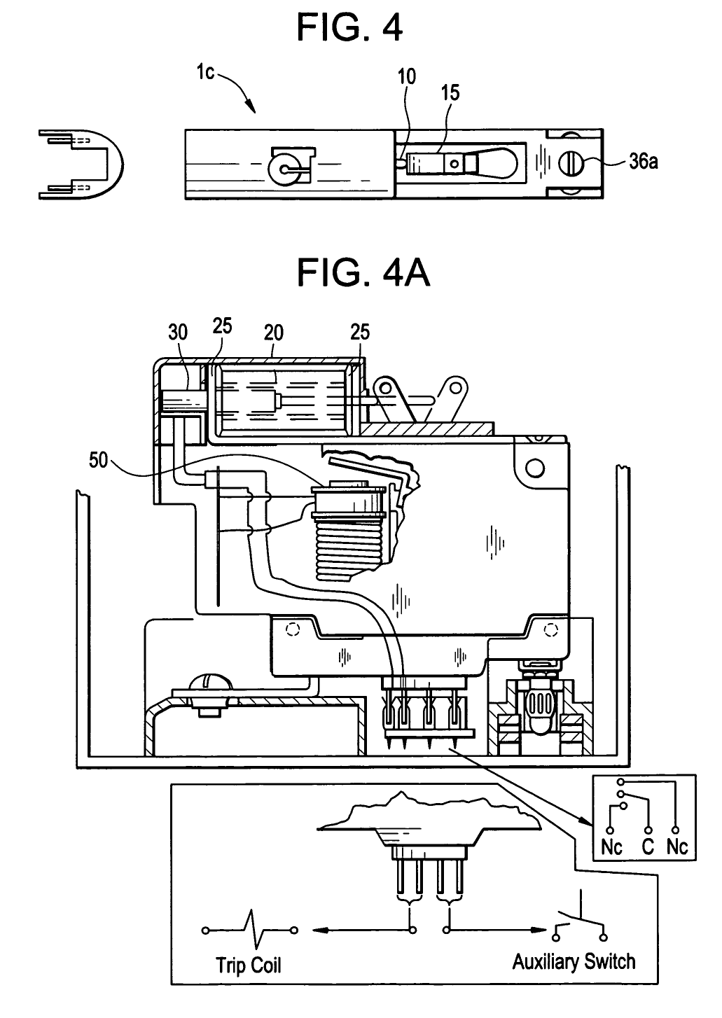

It noted for understanding that typically switch handle 15 has been “tripped” to an “off” position by a voltage trip coil 50 (see FIG. 4A) located in the circuit breaker, and at some time thereafter module 1b may be used to turn the circuit breaker 5 back “on” via plunger 10.

In FIG. 2, an optional handle guard or cover 21 is also included which may be a sealed cover in order to comply with MILC 55-629 standards for example or to seal the breaker from contaminants in general such as salt air in a marine application. The cover 21 may also be transparent. This guard may also be made to be removable in order to manually actuate the switch handle 15 if needed for example.

A second embodiment variation of the module discussed above is shown in FIGS. 3-4A at module 1c. It is significant to note that in this embodiment, the magnetic mounting frame 25 for solenoid 20 may be made to be integral and/or joined with an additional face plate 3 which has a mounting hole 4 that allows the switch handle 15 to travel through the face plate 3 as shown in FIG. 3. Face plate 3 may be provided with a screw hole 36 or other fastener which enables this second embodiment to be easily mounted on top of a preexisting circuit breaker 5 either to the circuit breaker itself or to a breaker panel 100. For example, circuit breakers 5 are typically fixed into place for operation in a circuit breaker panel 100 in a breaker box 110 as shown in FIGS. 3D and 3F for example. However, other breaker box configurations are possible and typically the size of the breaker box 110 depends on the application. The circuit breaker panel 100 typically is predrilled with a mounting hole 112 corresponding to the location of screw hole 36 for screw 36a. This predrilled hole 112 is usually included in circuit breaker panel 100, so it is easy for a technician to use this preexisting hole 112 for mounting and securing the face plate 3 and the module 1c. However, it also easy to drill a hole in the breaker panel 100 if not present to maintain a sealed environment after installation of screw 36a for example. Also, as shown in FIG. 3C, breaker box cover 115 may be fixed in place to seal the box. By comparing, FIGS. 3B to 3C, it is also readily apparent that a large retrofit device would not physically fit in the available space between the breaker box cover 115 and the breaker panel 110. Therefore, a low profile is important for retrofit devices. In order to save space, the mount or module may also be structured to mount the apparatus directly above the circuit breaker and within an area defined by vertically projecting the width of the circuit breaker upwards so that no additional width space is required for the module other than the width space located immediately above the circuit breaker 5. In other words, the width of the mount or module in any of the embodiments can be made small enough and have such a low profile by use of the solenoid that the width of the entire module or mount apparatus may be no wider than the circuit breaker if desired. This a major space saving benefit because no side breakers next to breaker need to be removed and no new breaker boxes need to be used or changed out for a retrofit for example.

Therefore, the module 1c which uses a relatively small profile solenoid 20 actuation also helps to minimize space requirements while increasing robustness, longevity, and reliability while reducing cost in comparison to mechanical, geared, or pneumatic systems. This helps this embodiment and the other similar embodiments comply with MILC 55-629 standards if required. Of course, any other suitable fastening methods may be used and this is just one specific example.

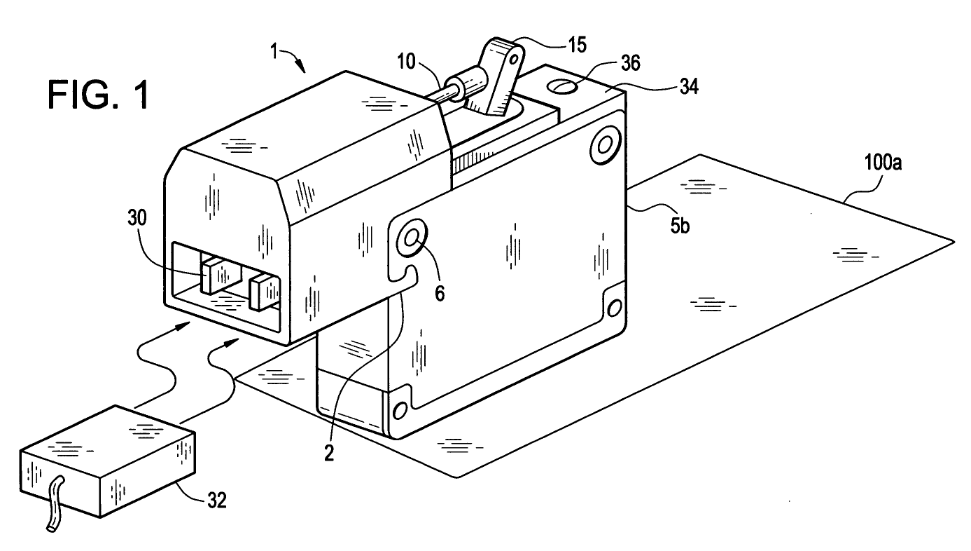

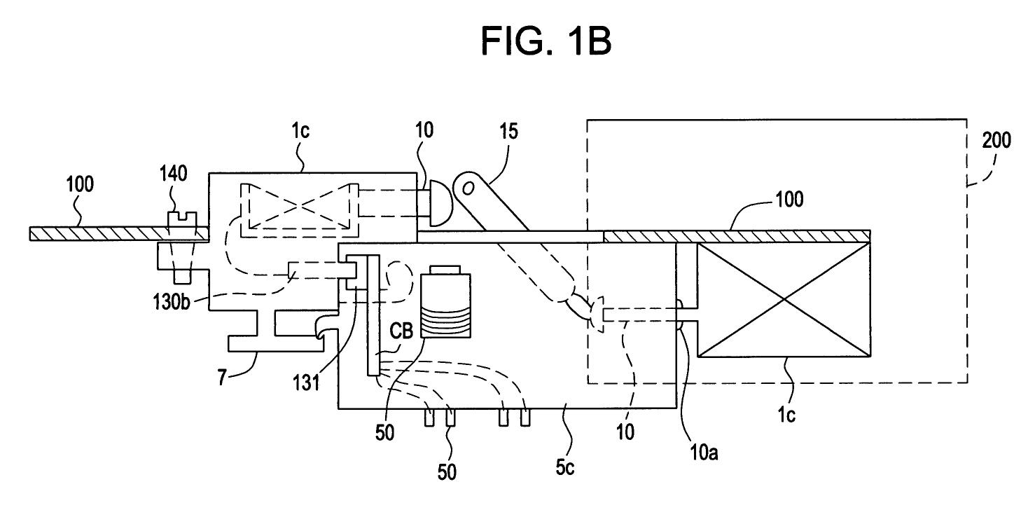

FIG. 3D also shows an exploded view of module 1c to be mounted in breaker box 110. Wires 120 may be used to power the module 1c and may easily be connected to suitable buses 121 for example. However, other connectors such as connector 32 in FIG. 1 as described below may also be used, and single pole and di-pole connectors may also be used as described below or in any desired connector arrangement.

FIG. 3D shows a particular breaker box 110 however all of the accessories shown in the breaker box are not necessary for the basic invention. For example, CAN (Communication Area Network) connectors 163 which are connected to optional IC circuit boards 164 may be implemented in the breaker box 110 in order to create a “smart breaker box” which can remotely monitor the status of the circuit breakers 5 and/or be used as an interface to remotely actuate the circuit breakers via the actuator modules described above such as module 1c for example and also to control other functions in the breaker box. Therefore, the module 1c can enable an entire smart breaker box system with remote actuator control and status and control user displays and interfaces (not shown) because the remote actuation function is easily implemented due to the present invention. For example, a ship could retrofit the modules 1c or have them as original equipment, and use a breaker box like breaker box 100 to enable “smart” remote monitoring and control of the circuit breakers of the ship from the helm station or wheelhouse for example. Alternatively, a “dumb” breaker box can be used, and a normal switch could be located remotely to actuate the circuit breakers remotely. For example, a toggle switch could be located near the steering wheel of the ship and if the user lost power he could simply assume by knowing the ships circuits that the respective breaker had tripped and then try to turn the breaker on again remotely with the toggle switch rather than going down to the engine room and flipping the breaker switch back on manually. This could be very useful if the ship was in the process of maneuvering when the breaker tripped and would not require a smart breaker box for example. Therefore, retrofitting the modules to existing breaker boxes or using a combination of the present embodiments as originally installed or retrofit equipment could be very useful in many different applications including military, aviation, and marine applications for example.

FIG. 3E shows a slightly different version of the above where a latch 7 made to latch into a hole in breaker panel 100. Therefore, it can be readily seen that many different latch arrangements are possible depending on the application.

FIG. 4A also shows an optional voltage trip coil circuit at box 600.

Thus, modules 1, 1b, and other embodiments, may compromise an actuator plunger 10 which is moveable to contact circuit breaker 5 switch handle 15 in order to move switch handle 15 (See FIG. 3). Plunger 10 is connected to a solenoid 20 that moves plunger 10 axially. The solenoid 20 is mounted in a magnetic mounting frame 25 (see the third embodiment shown in FIG. 3 for a view of the solenoid 20 and mounting frame 25) that cradles the solenoid 20, and that holds the solenoid 20 in place. In these embodiments, the mounting frame 25 is made of iron but any suitable magnetic material may be implemented.

FIG. 1 illustrates a different third embodiment. In this embodiment, Module 1 is mounted to a circuit breaker 5b via a “slide on” arrangement. In this embodiment, the circuit breaker 5b is custom made to accept slide on module 1. Although any appropriate slide on system may be used, in this example, slide on module 1 is fixed into place by resilient tabs 2 and 7 which can be deformed to “snap” into place with necessitating the use of screws or other fasteners. Therefore, in this embodiment it is very easy for a customer who first buys the circuit breakers 5b to snap the module 1 into place when remote actuation is decided upon as a retrofit for example. This arrangement is also suitable to meet MILC 55-629 standards if required such as resistance to vibration and other requirements.

Alternatively, this module 1c can be shipped as original equipment, i.e., already “slid or snapped on” and installed on the breaker. This is more beneficial for the customer in comparison to an “all in one” custom made remote actuatable circuit breaker unit, because if the circuit breaker 5b experiences too many overload or short circuit events, it can be easily replaced without having to discard the remote actuator mechanism as well. This saves time and money. Also, it is important, that the present invention does not take up any more space in the breaker panel 100 than a standard manual circuit breaker because the module is located physically above the circuit breaker 5b. Circuit breaker 5b can also be designed to locate the slide on module 1 when installed above the plane of circuit breaker panel 100a as shown in FIG. 1 or alternatively the circuit breaker panel 100a can be cut or modified by the technician in the field to allow module 1 to physically fit on the circuit breaker 5 when it is mounted in a breaker panel of a breaker box (not shown).

FIG. 1C is a side view of the third embodiment shown in FIG. 1 but with an optional screw 36 that mounts the plate to the circuit breaker on one end when the circuit breaker is made with a screw hole. The hole may also be located in the breaker panel 100 depending upon the application and user preference. FIG. 1C also shows a possible version of optional latch 7. However, many different versions of latches are also envisioned. Circuit breaker 5d is also made to have latch tab 7a.

FIG. 1B shows slightly different locations of module 1c. For example solenoid power connector 130b is located in this version such that when module 1c in slid into place in a “slide on” manner, the electrical connector 130b is also automatically connected because it takes the shape of a prong that engages with circuit breaker 5c having receiving connector 31 or vice versa. Fastener 140 is also shown which may be used to secure an end of module 1c to the breaker panel 100. FIG. 1B also shows a possible alternative location for module 1c on the right side of the figure at box 200. In this right side version, module 1c, actually actuates the switch lever 15 below the surface of the circuit breaker 5c by having the plunger 10 enter the circuit breaker through an opening 10a.

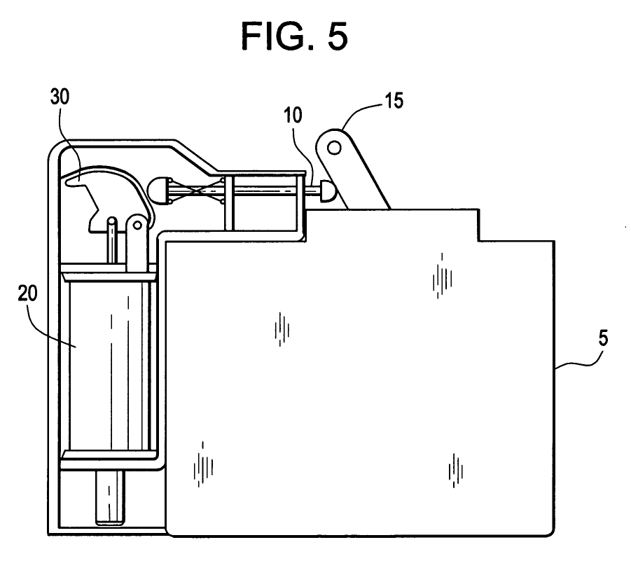

A fourth embodiment is shown in FIG. 5. In this embodiment the plunger 10, is not directly connected to the solenoid 20. Instead, in order to enable a side mounting of the solenoid 20, an additional intermediate member 30 is implemented at the corner to transfer the actuation action from the solenoid 20 to the plunger 20. This is also an embodiment which is small in size and which is easily retrofittable to a standard breaker if required. Any suitable fastening means may be used as discussed above.

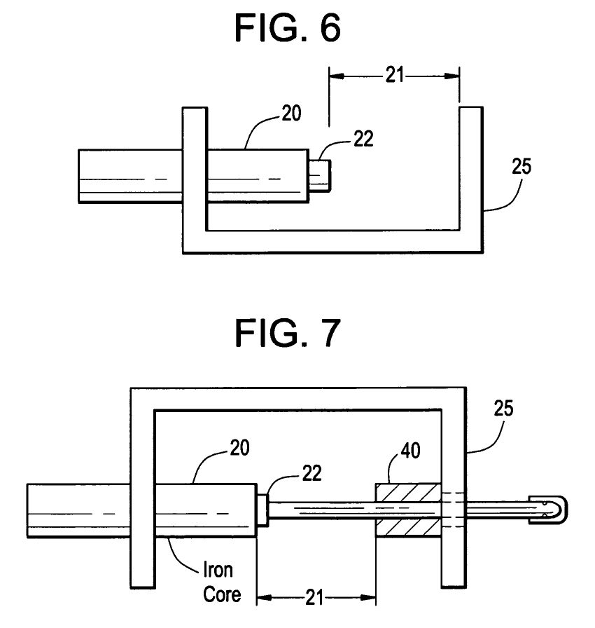

A fifth embodiment is shown in FIG. 7. In this embodiment, a spacer 22 is included as shown and effectively enhances the working gap 21 of the solenoid. This increases the magnetic efficiency of the solenoid by using the area of maximum magnetic flux in comparison to FIG. 6 for example where the working gap 21 is located to the right of the maximum area of magnetic flux. Thus, using the magnetically permeable spacer 22 may also reduce the heat produced by the solenoid 20 and may also increase the effective resultant force of the solenoid 20.

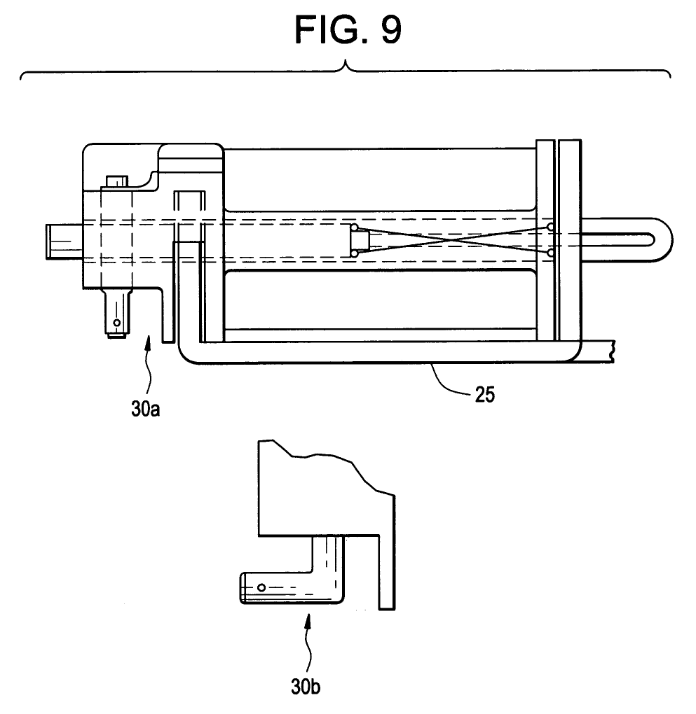

An additional mounting frame arrangement with other exemplary terminal electrical connector options such as single poles 30A or 30B is shown in FIG. 9. Thus, many configurations of connectors are possible as is well known in the electrical connector art.

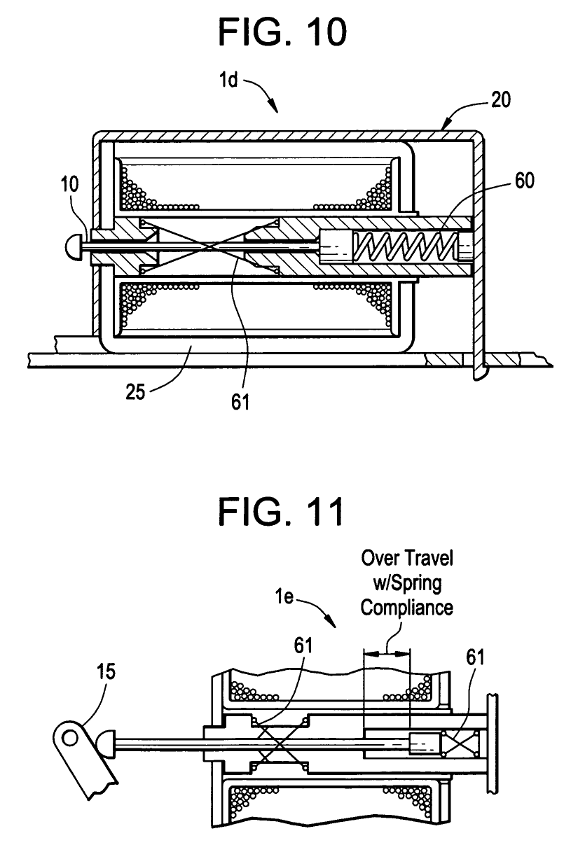

A sixth and seventh embodiment is shown in FIGS. 10 and 11. In this embodiment, spring 60 is included to dampen the violent actuation of plunger 10 thereby increasing the overall life of the module 1d. Helical compression springs 61 are also be used or added as shown on module 1e to control spring run length 61b.

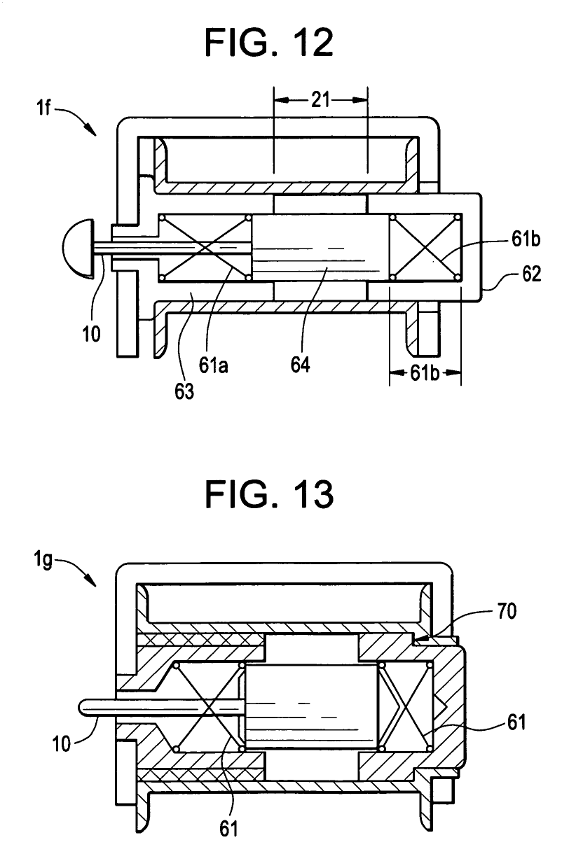

FIG. 12 is a side sectional view of the eighth embodiment, module 1f. This embodiment depicts a magnetic moveable end core 62 (for example made of iron) which is attracted to pole piece 63 in which spring 61a and 61b are balanced so that non magnetic permeable slug 64 positions itself as shown and is driven forward to actuate upon attraction of core 62 to pole 63.

FIG. 13 is a side sectional view of a ninth embodiment module 1g having a hard stop 70 and helical compression springs 61 to reduce wear on the mechanism for example when the circuit breaker is turned on. Other spring types may be used. FIG. 13 is the same as FIG. 12 except for the hard or positive stop 70 on core 62. For example, cone springs or other springs.

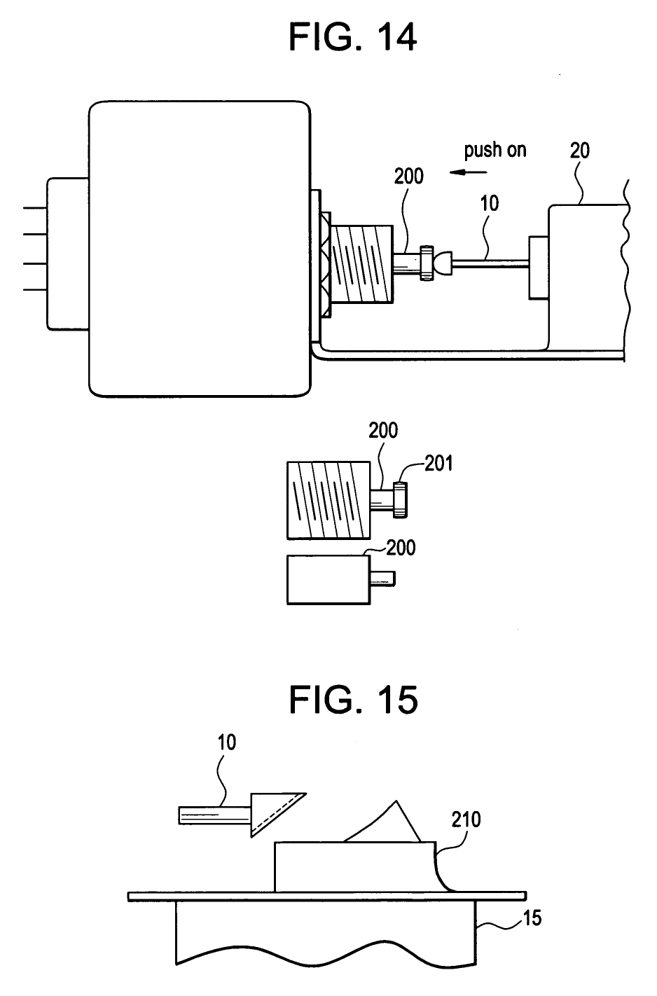

FIG. 14 shows an embodiment where a push button switch 200 is used on the circuit breaker instead of a switch handle. Push button circuit breakers are common and this invention is meant to operate and cover push button circuit breakers as well in many configurations. Lip 201 may be included so that the push button can be manually grasped and pulled out if needed.

FIG. 15 shows an embodiment where a rocker switch breaker is used on the circuit breaker instead of a switch handle. Rocker switch circuit breakers are common and this invention is meant to operate and cover rocker switch circuit breakers as well in many configurations.

Therefore, from the embodiments described above it can be seen that many modifications are possible and apparent to one skilled in the art regarding the exact location of the solenoid 20. Thus, the scope of this disclosure is not limited to the specific embodiments disclosed above.

In operation, the solenoid 20 actuates the plunger 10. Any suitable controller (not shown) may be used to control the solenoid 20. A solenoid uses magnetic internals. Thus, gears, traditional motors, or complex circuitry are not are required which increases reliability. In addition to being less complex and less costly than a geared or motorized system, the solenoid 20 is much more reliable and rugged then typical geared or motorized applications.

Moreover, the embodiments may be more compact in comparison to prior art motorized devices which typically require a mounting space or mounting “hole” equal to two standard circuit breakers in width due to the fact that the prior art actuator motors are located in a side-by-side manner with the circuit breakers.

In contrast as discussed above, a present embodiment may be mounted vertically and “on top of” a pre-existing circuit breaker 5, for example and does not require an existing circuit breaker to be removed. Therefore, for example, if twenty circuit breakers are arranged in a row, the present embodiment may be retrofitted onto each of the individual pre-existing circuit breakers without requiring any of the pre-existing circuit breaker 5 to be removed. Therefore, even after a retrofit, twenty circuit breakers would remain.

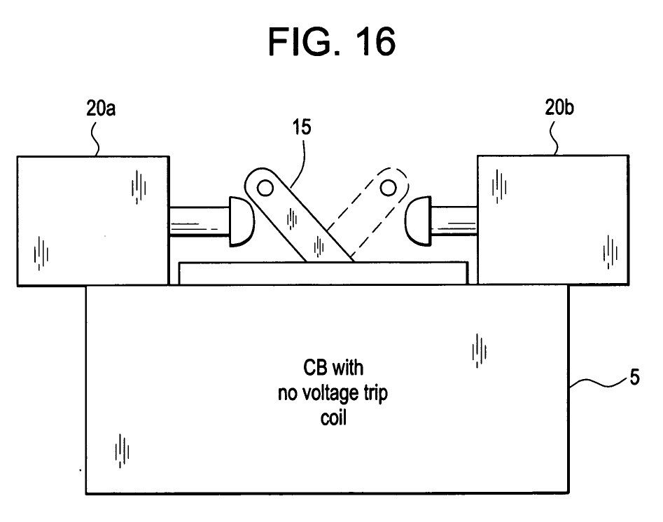

FIG. 16 is a side view of another embodiment useable if there is no internal voltage trip coil in the circuit breaker. In this embodiment two solenoid modules (20a, 20b) are mounted on opposite sides of the circuit breaker 5 lever switch 15. The solenoid modules 20a, 20b, are used to turn the circuit breaker on and off, respectively.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments and equivalents falling within the scope of the claims.

What is claimed is:

1. A remotely actuated circuit breaker actuator apparatus for use with a circuit breaker having a switch actuator comprising:
a solenoid;
a moveable plunger actuated by the solenoid;
a mount for holding the solenoid;
wherein the mount is structured to be mountable to the exterior of the circuit breaker in order to position the plunger proximate to the switch actuator in order to actuate the switch actuator remotely via the solenoid.

2. The apparatus of claim 1 further comprising:
a guard for enclosing the solenoid and the plunger.

3. The apparatus of claim 1 further comprising:
a mounting plate structured to be placed on top on the circuit breaker and connected to the mount.

4. The apparatus of claim 1 further comprising:
an intermediate member located between the plunger and the solenoid.

5. The apparatus of claim 1 further comprising:
a magnetically permeable spacer located on the plunger.

6. The apparatus of claim 1 further comprising:
an electrical connector for powering the solenoid.

7. The apparatus of claim 1 further comprising:
springs for dampening movements of the plunger.

8. The apparatus of claim 1 wherein the mount is a slideable mount.

9. The apparatus of claim 8 wherein the mount is a slideable mount and a power connector is included which is structured to engage when the slideable mount is slid onto the circuit breaker.

10. The apparatus of claim 1 wherein the width of the module is no wider than the width of the circuit breaker.

11. The apparatus of claim 1 wherein the apparatus is sealed from contaminants.

12. The apparatus of claim 1 wherein the mount has latches.

13. The apparatus of claim 1 wherein the mount is structured to mount the apparatus directly above the circuit breaker and within an area defined by vertically projecting the width of the circuit breaker upwards so that no additional width space is required for the module other than the width space located immediately above the circuit breaker.

14. The apparatus of claim 1 wherein the apparatus complies with MILC 55-629 standards.

15. A remotely actuated circuit breaker actuator apparatus for retrofitting to a circuit breaker located in a breaker box where the circuit breaker has a switch actuator, comprising:
a module comprising:
a solenoid;
a moveable plunger actuated by the solenoid;
a mount for holding the solenoid;
wherein the mount is structured to be mountable above the circuit breaker in order to position the plunger proximate to the switch actuator in order to actuate the switch actuator remotely via the solenoid.

16. The apparatus of claim 15 further comprising:
a guard for enclosing the solenoid and the plunger.

17. The apparatus of claim 15 further comprising:
a mounting plate structured to be placed on top on the circuit breaker and connected to the module.

18. The apparatus of claim 15 further comprising:
an intermediate member located between the plunger and the solenoid.

19. The apparatus of claim 15 further comprising:
a magnetically permeable spacer located on the plunger.

20. The apparatus of claim 15 further comprising:
an electrical connector for powering the solenoid.

21. The apparatus of claim 15 further comprising:
springs for dampening movements of the plunger.

22. The apparatus of claim 15 wherein the module is structured to be slide mountable.

23. The apparatus of claim 15 wherein the mount is a slide mount and a power connector is included which is structured to engage when the slide mount is slid onto the circuit breaker.

24. The apparatus of claim 15 wherein the width of the module is no wider than the width of the circuit breaker.

25. The apparatus of claim 15 wherein the apparatus is sealed from contaminants.

26. The apparatus of claim 15 wherein the apparatus complies with MILC 55-629 standards.

27. The apparatus of claim 15 wherein the module has latches.

28. The apparatus of claim 15 wherein the module is structured to mount the module directly above the circuit breaker and within an area defined by vertically projecting the width of the circuit breaker upwards so that no additional width space is required for the module other than the width space located immediately above the circuit breaker.

29. A system comprising:
at least one circuit breaker having a switch actuator;
at least one remotely actuated circuit breaker actuator apparatus for mating with each circuit breaker having a switch actuator comprising:
a solenoid;
a moveable plunger actuated by the solenoid;
a mount for holding the solenoid;
wherein the mount is mountable to the exterior of each circuit breaker in order to position the plunger proximate to the switch actuator in order to actuate the switch actuator remotely via the solenoid and wherein each circuit breaker is mated to a dedicated remotely actuated circuit breaker actuator apparatus;
a breaker panel wherein each remotely actuated circuit breaker actuator apparatus may be mounted;
a breaker box wherein the breaker panel is mounted; and
control electronics linked to the circuit breakers and linked to each remotely actuated circuit breaker actuator apparatus via a communications connection for controlling the actuation of each remotely actuated circuit breaker actuator apparatus.
